(19) United States
(12) Patent Application Publication
(10) Pub. No.: US 2019/0137044 A1
(43) Pub. Date: May 9, 2019

(54) LEAKAGE POSITION ANALYZING SYSTEM, LEAKAGE POSITION ANALYZING METHOD, LEAKAGE POSITION ANALYZING DEVICE, AND COMPUTER-READABLE RECORDING MEDIUM

(71) Applicant: NEC Corporation, Minato-ku, Tokyo (JP)

(72) Inventors: Masatake TAKAHASHI, Tokyo (JP); Hirofumi INOUE, Tokyo (JP); Shin TOMINAGA, Tokyo (JP)

(73) Assignee: NEC Corporation, Minato-ku, Tokyo (JP)

(21) Appl. No.: 16/096,396

(22) PCT Filed: Apr. 19, 2017
(86) PCT No.: PCT/JP2017/015650

§ 371 Date: Oct. 25, 2018

(30) Foreign Application Priority Data
Apr. 28, 2016 (JP) 2016-091996

(51) Int. Cl. F17D 5/02; G01M 3/24; F17D 5/00; F17D 1/02

(52) U.S. Cl. CPC F17D 5/02; F17D 1/02; F17D 5/005; G01M 3/243

(57) ABSTRACT

A leakage position analyzing system includes: a first wave motion detector installed in a first pipe; a second wave motion detector installed in a second pipe connected to the first pipe; a wave motion applying device applying a wave motion to the first pipe; and a leakage position calculator calculating a fluid leakage position on the basis of the difference between the time at which the wave motion reaches the first wave motion detector and the time at which the wave motion reaches the second wave motion detector, a length La from the location in which the first wave motion detector is installed to the location of the connection with the second pipe, and a length Lb from the location in which the second wave motion detector is installed to the location of the connection with the first pipe.

This application is a National Stage Entry of PCT/JP2017/015650 filed on Apr. 19, 2017, which claims priority from Japanese Patent Application 2016-091996 filed on Apr. 28, 2016, the contents of all of which are incorporated herein by reference, in their entirety.

### TECHNICAL FIELD

The present invention relates to a leakage position analyzing system, a leakage position analyzing method, a leakage position analyzing device, and a computer-readable recording medium.

### BACKGROUND ART

In modern life, pipe networks for transporting fluid in, such as water and sewerage networks and high-pressure chemistry pipelines for gas, petroleum, and the like, are constructed as infrastructures on which prosperous society is based. If the pipe networks are destroyed due to an unexpected natural disaster, such as an earthquake disaster, or deterioration in service life, and the destruction leads to a serious accident, impact on the society is considerable, which causes a large economic loss. Pipes used for constructing the pipe networks deteriorate due to corrosion, abrasion, backlash, or the like depending on used hours.

As an inspection for finding a fluid leakage, an audibility sensory inspection in which a person catches leakage sounds is generally conducted. However, the leakage inspection by auditory sensation greatly depends on expert's skills.

To solve such a problem, an inspection method and an inspection device for inspecting a leakage position by a machine have been proposed. PTL 1 describes a method in which a vibration is applied by a vibrator, which is installed on a conduit buried in the ground, and this vibration is detected by vibration sensors installed at intervals on the conduit, thereby measuring a vibration propagation velocity of the conduit and specifying a fluid leakage position. Further, PTL 2 describes an abnormal position detection device which discriminates, at each frequency, received signals from two ultrasonic sensors provided across an abnormal part of a conduit, thereby making it possible to accurately specify the abnormal position in consideration of a velocity dispersion dependence of a leakage sound propagation velocity.

### CITATION LIST

### Patent Literature

[PTL 1] Japanese Unexamined Patent Application Publication No. H11 (1999)-201858

[PTL 2] Japanese Unexamined Patent Application Publication No. 2006-3311

[PTL 3] Japanese Unexamined Patent Application Publication No. H11 (1999)-210999

### SUMMARY OF INVENTION

### Technical Problem

However, when materials or diameters of pipes change in measurement intervals of two sensors, accuracy for specifying a leakage position by a conventional inspection method and inspection device for inspecting the leakage position by a machine is insufficient. In general, the materials or the diameters of pipes may change in the measurement intervals of two sensors due to a work for exchanging a pipe which has deteriorated due to corrosion or the like caused by aged deterioration. The method and device described in PTLs 1 and 2 have a problem that, when a plurality of types of pipes coexist as described above, vibrations of individual pipes and a propagation velocity of a leakage sound cannot be calculated, which leads to a deterioration in accuracy for specifying a leakage position.

Therefore, an object of the present invention is to provide a leakage position analyzing system, a leakage position analyzing method, and a leakage position analyzing device which are capable of accurately analyzing a fluid leakage position even when a plurality of types of pipes coexist and materials or diameters of the pipes are different.

### Solution to Problem

A leakage position analyzing system of an embodiment includes:

a first wave motion detector that is installed in a first pipe;

a second wave motion detector that is installed in a second pipe connected to the first pipe;

a wave motion applying device that applies wave motion to a side not connected to the second pipe in the first pipe, from a location where the first wave motion detector is installed; and

a leakage position calculator that calculates a fluid leakage position, using a difference between a time when the wave motion reaches the first wave motion detector and a time when the wave motion reaches the second wave motion detector, a length of a part of the first pipe from the location where the first wave motion detector is installed, to a location of a connection with the second pipe, and a length of a part of the second pipe from a location where the second wave motion detector is installed, to a location of a connection with the first pipe.

A leakage position analyzing method of an embodiment includes:

applying a wave motion from a location of where a first wave motion detector is installed, to a side not connected to a second pipe in the first pipe, the second pipe being connected to the first pipe; and

calculating a fluid leakage position, using a difference between a time when the wave motion reaches the first wave motion detector and a time when the wave motion reaches second wave motion detector installed in the second pipe, a length of a part of the first pipe from the location where the first wave motion detector is installed, to a location of a connection with the second pipe, and a length of a part of the second pipe from a location where the second wave motion detector is installed, to a location of a connection with the first pipe.

A leakage position analyzing device of an embodiment includes:

a first wave motion detector that is installed in a first pipe;

a second wave motion detector that is installed in a second pipe connected to the first pipe; and

a leakage position calculator that calculates a fluid leakage position, using a difference between a time when the wave motion reaches the first wave motion detector and a time when the wave motion reaches the second wave motion detector, a length of a part of the first pipe from the location where the first wave motion detector is installed, to a location of a connection with the second pipe, and a length of a part of the second pipe from a location where the second wave motion detector is installed, to a location of a connection with the first pipe.

A computer-readable recording medium of an embodiment records a program causing a computer to execute a leakage position analyzing method including:

applying a wave motion from a location of where a first wave motion detector is installed, to a side not connected to a second pipe in the first pipe, the second pipe being connected to the first pipe; and

calculating a fluid leakage position, using a difference between a time when the wave motion reaches the first wave motion detector and a time when the wave motion reaches a second wave motion detector installed in the second pipe, a length of a part of the first pipe from the location where the first wave motion detector is installed, to a location of a connection with the second pipe, and a length of a part of the second pipe from a location where the second wave motion detector is installed, to a location of a connection with the first pipe.

### Advantageous Effects of Invention

According to the present invention, it is possible to provide a leakage position analyzing system, a leakage position analyzing method, and a leakage position analyzing device which are capable of accurately analyzing a fluid leakage position even when a plurality of types of pipes coexist and materials or diameters of the pipes are different.

### BRIEF DESCRIPTION OF DRAWINGS

FIG. 1 is a schematic diagram illustrating an example where a leakage position analyzing system according to a first example embodiment is installed.

FIG. 2 is a schematic block diagram illustrating an example of a structure of the leakage position analyzing system according to the first example embodiment.

FIG. 3 is a graph illustrating a frequency dependence of a wave motion propagation velocity of a pipe.

FIG. 4 is a graph illustrating an example of data processing by a wave motion propagation velocity calculator according to the first example embodiment.

FIG. 5 is a graph illustrating an example of data processing by a leakage position calculator according to the first example embodiment.

FIG. 6 is a graph illustrating an example of a cross-correlation function calculated by using wave motion data detected by a first wave motion detector and a second wave motion detector according to the first example embodiment.

FIG. 7 is a graph illustrating an example of data processing by a wave motion propagation velocity calculator according to a second example embodiment.

FIG. 8 is a graph illustrating an example of data processing by a wave motion propagation velocity calculator according to a third example embodiment.

FIG. 9 is a schematic block diagram illustrating an example of a structure of a leakage position analyzing device according to a fifth example embodiment.

FIG. 10 is a schematic block diagram illustrating an example of a structure of a leakage position analyzing device according to a sixth example embodiment.

FIG. 11 is a flowchart illustrating an example of an operation of the leakage position analyzing system according to the first example embodiment.

FIG. 12 is a diagram illustrating an example of a structure of an information processing device that executes a program for a leakage position calculation method according to a fourth example embodiment.

### EXAMPLE EMBODIMENT

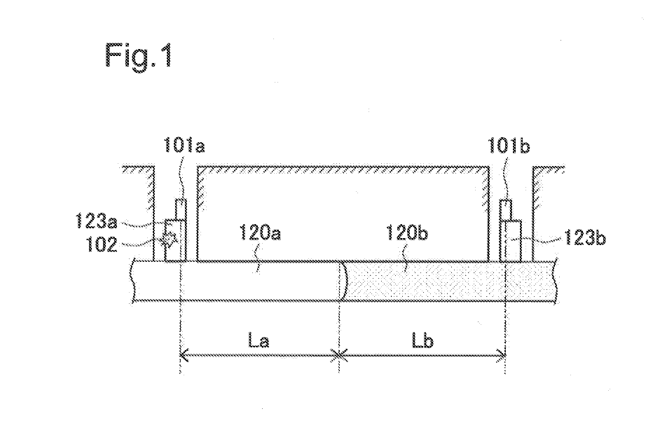

A leakage position analyzing system, a leakage position analyzing method, a program, a recording medium and a leakage position analyzing device according to the present invention will be described in detail below with reference to the drawings, taking a case where pipes are water pipes buried in soil as an example. It is noted that the present invention is not limited to the following descriptions. The present invention can be widely used not only for water pipes buried in soil, but also for water pipes that are not buried in soil, pipes through which fluid such as petroleum and gas flows, and the like. In addition, in FIGS. 1 to 10 to be described below, the same parts are denoted by the same reference numerals, and the descriptions thereof may be omitted. In the drawings, for convenience of explanation, the structure of each part may be simplified as needed, and a scale ratio and the like of respective parts may be different from the actual parts and schematically illustrated.

### First Example Embodiment

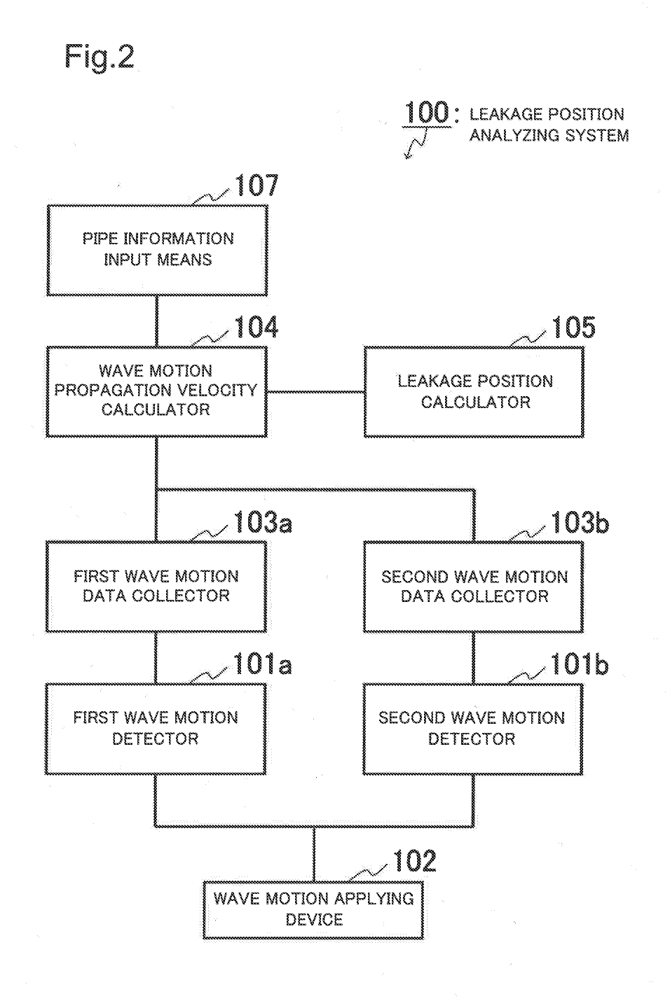

A schematic diagram of FIG. 1 illustrates an example of construction of a leakage position analyzing system according to a first example embodiment. A schematic block diagram of FIG. 2 illustrates an example of a configuration of the leakage position analyzing system according to the first example embodiment. As illustrated in FIG. 2, the leakage position analyzing system 100 according to the first example embodiment includes a first wave motion detector 101a, a second wave motion detector 101b, a wave motion applying device 102, a first wave motion data collector 103a, a second wave motion data collector 103b, a wave motion propagation velocity calculator 104, a leakage position calculator 105, and a pipe information input device 107. In the leakage position analyzing system 100 according to the first example embodiment, the first wave motion data collector 103a, the second wave motion data collector 103b, the wave motion propagation velocity calculator 104 and the pipe information input device 107 are constituent members provided as necessary, and these members are preferably included, but need not be included.

The first wave motion detector 101a and the second wave motion detector 101b are any detector as long as they can detect wave motion of a pipe. For example, the first wave motion detector 101a and the second wave motion detector 101b are a sensor to detect wave motion, a sensor to detect a pressure fluctuation, or the like.

The first wave motion detector 101a is installed in a first pipe 120a. The first wave motion detector 101a may be directly installed in the first pipe 120a, or may be installed in the first pipe 120a through a valve plug member 123a as illustrated in FIG. 1. Examples of the valve plug member 123a include a fire hydrant, a water shut-off valve, an air valve, and the like connected to the first pipe 120a.

The second wave motion detector 101b is installed in a second pipe 120b connected to the first pipe 120a. The second wave motion detector 101b may be directly installed in the second pipe 120b, or may be installed in the second pipe 120b through a wave plug portion 123b as illustrated in FIG. 1. Examples of the valve plug member 123b include a fire hydrant, a water shut-off valve, an air valve, or the like connected to the second pipe 120b.

The wave motion applying device 102 is a device for applying wave motion to a side not connected to the second pipe 120b in the first pipe 120a, from a location where the first wave motion detector 101a is installed. The wave motion applying device 102 may be any device as long as the device can apply the wave motion to the pipe. For example, the wave motion applying device 102 is a speaker, a hammer, or the like capable of applying an impact. Referring to FIG. 1, the wave motion applying device 102 may be installed at any location, as long as the wave motion can be applied to a location other than a range of the first pipe 120a which is indicated by an arrow La. For example, the wave motion applying device 102 may be installed in the valve plug member 123a as illustrated in FIG. 1, and may apply the wave motion to a location other than the range of the first pipe 120a indicated by the arrow La through the valve plug member 123a.

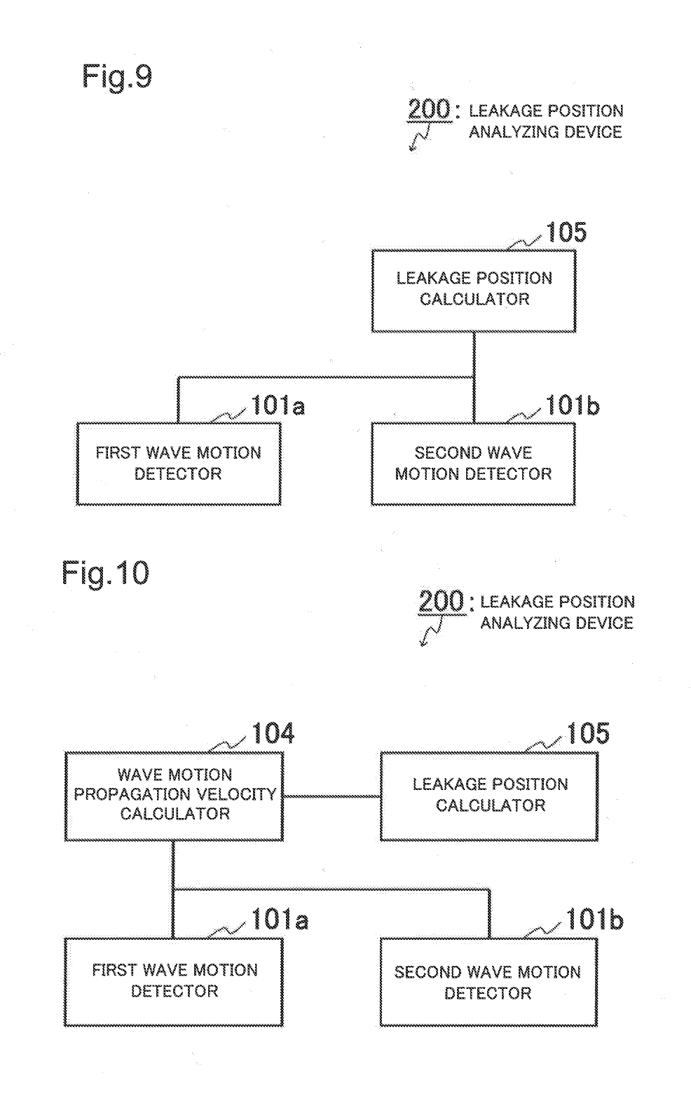

A leakage position analyzing method using the leakage position analyzing system 100 in the installation example illustrated in FIG. 1 is carried out, for example, in the following manner. First, the wave motion applied by the wave motion applying device 102 is detected by the first wave motion detector 101a and the second wave motion detector 101b. And, wave motion data about the detected wave motion is collected by the first wave motion data collector 103a and the second wave motion data collector 103b, and is transmitted to the wave motion propagation velocity calculator 104. As described above, in the leakage position analyzing system 100, the first wave motion data collector 103a and the second wave motion data collector 103b are constituent members provided as necessary. The wave motion data about the wave motion detected by the first wave motion detector 101a and the second wave motion detector 101b may be directly transmitted to the wave motion propagation velocity calculator 104, not through the first wave motion data collector 103a and the second wave motion data collector 103b. As described above, in the leakage position analyzing system 100, the wave motion propagation velocity calculator 104 is the constituent member provided as necessary. The wave motion data about the wave motion detected by the first wave motion detector 101a and the second wave motion detector 101b may be directly transmitted to the leakage position calculator 105 as illustrated in FIG. 9.

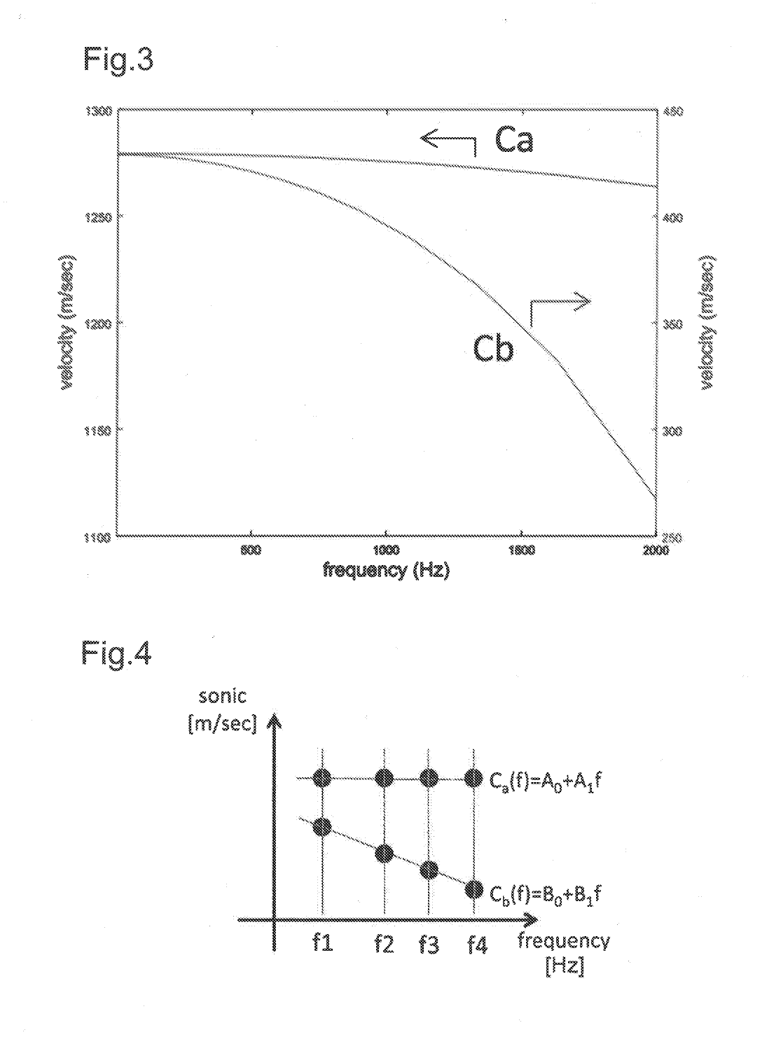

Next, data processing by the wave motion propagation velocity calculator 104 will be described by using FIGS. 3 and 4. Note that when the leakage position analyzing system 100 according to the first example embodiment does not include the wave motion propagation velocity calculator 104, this data processing may be carried out by the leakage position calculator 105. A difference (arrival time difference) between a time when the wave motion applied by the wave motion applying device 102 reaches the first wave motion detector 101a and a time when the wave motion reaches the second wave motion detector 101b is expressed by a mathematical formula (1). Note that as illustrated in FIG. 1, in a case where the first wave motion detector 101a and the second wave motion detector 101b are installed in the valve plug member 123a and the valve plug member 123b, respectively, a time required for the wave motion to propagate through the valve plug member 123a and the valve plug member 123b is extremely shorter than a time required for the wave motion to propagate through the first pipe 101a and the second pipe 101b, and thus is negligible.

$$[ Formula 1 ]$$

$${t}_{p} ( f ) = \frac{{L}_{a}}{{C}_{a}} + \frac{{L}_{b}}{{C}_{b}} \qquad ( 1 )$$

In the mathematical formula (1), tp(f) represents the arrival time difference at a frequency f. La represents a length from the location where the first wave motion detector 101a is installed to a location of a connection with the second pipe 120b (see FIG. 1). Lb represents a length from the location where the second wave motion detector 101b is installed to a location of a connection with the first pipe 120a (see FIG. 1). Ca represents a wave motion propagation velocity of the first pipe 120a. Cb represents a wave motion propagation velocity of the second pipe 120b. La and Lb are input to the wave motion propagation velocity calculator 104 from a registry or the like by the pipe information input device 107. Note that, as described above, in the leakage position analyzing system 100, the pipe information input device 107 is the constituent member provided as necessary. La and Lb may be held by the wave motion propagation velocity calculator 104 in advance. The wave motion propagation velocity calculator 104 calculates unknown quantities Ca and Cb.

In this case, it is known that the wave motion propagation velocity of a pipe shows a frequency dependence. A graph of FIG. 3 illustrates a frequency dependence of a wave motion propagation velocity of each of a cast iron pipe and a plastic pipe. In FIG. 3, Ca represents the frequency dependence of the wave motion propagation velocity of the cast iron pipe, and Cb represents the frequency dependence of the wave motion propagation velocity of the plastic pipe.

In the first example embodiment, two curves illustrated in FIG. 3 are approximated with linear curves represented by mathematical formulas (2) and (3), respectively.

[Formula 2]

Cₐ(f)=A₀+A₁f (2)

C_{b}(f)=B₀+B₁f (3)

In the mathematical formulas (2) and (3), A0, A1, B0, and B1 are unknown quantities to be individually determined. When mathematical formulas (2) and (3) are substituted into the mathematical formula (1), an equation including four unknown quantities is obtained. As illustrated in FIG. 4, the wave motion propagation velocity calculator 104 calculates a plurality of (four in this example) frequency components tp, thereby determining these unknown quantities. The method for calculating the tp is not particularly limited. For example, a method using a digital filter, a method using a fast Fourier transform and the like can be cited. Also, the method for determining four unknown quantities is not particularly limited. Examples of the method include a solution to a typical simultaneous non-linear equation, including a least squares method, and the like.

Note that the unknown quantities can be determined based on five or more frequency components. In this case, accuracy for estimating the unknown quantities is enhanced.

In the estimation of the unknown quantities, the wave motion propagation velocity can be more stably estimated by using, as an initial value, the formula for a water hammer propagation velocity, which is well known as hydraulics, based on information such as materials, diameters, and laying position information of pipes input from the pipe information input device 107.

Next, the leakage position calculator 105 calculates a leakage position by using the wave motion propagation velocity obtained by using the determined unknown quantities. Note that an occurrence of leakage may be determined, for example, by a conventionally known method, such as a determination method using a threshold set to a frequency spectrum of the wave motion. When calculation of the leakage position is performed, the wave motion data about the wave motion detected by the first wave motion detector 101a and the second wave motion detector 101b in a state where no wave motion is applied by the wave motion applying device 102 is used.

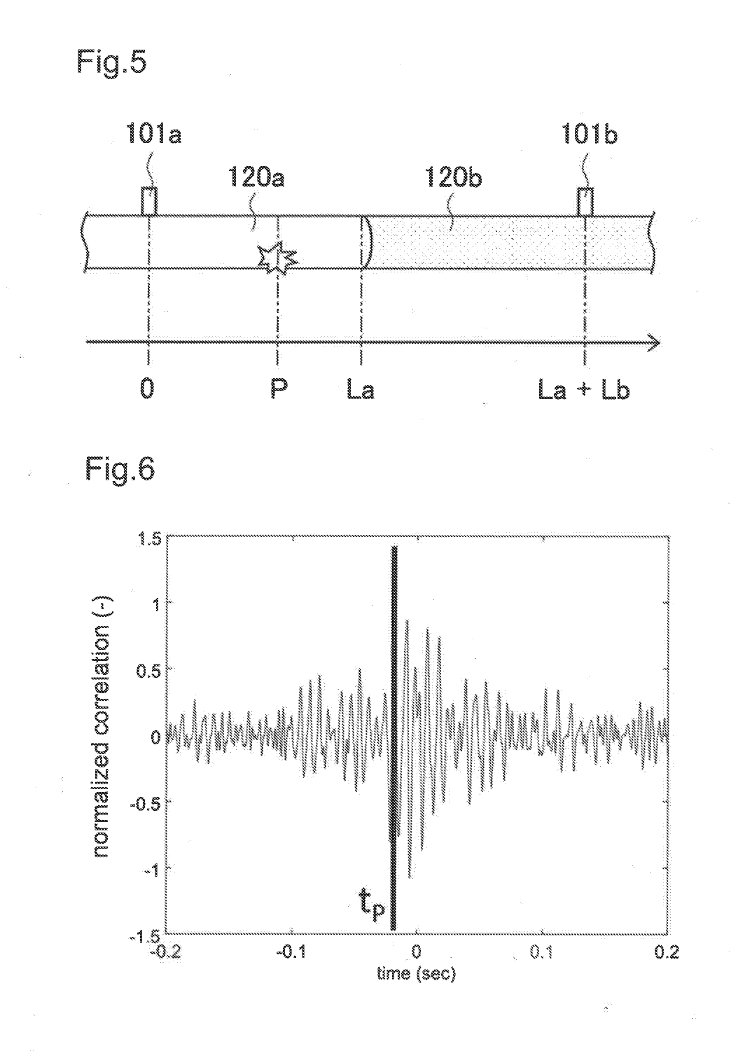

For example, as illustrated in FIG. 5, when a leakage occurs at a point P, the tp is calculated from a peak of a cross-correlation function which is illustrated in FIG. 6 and calculated by using the wave motion data about the wave motion detected by the first wave motion detector 101a and the second wave motion detector 101b, and a leakage position P is calculated by using a mathematical formula (4). Note that in FIG. 5, illustration of the valve plug member 123a and the valve plug member 123b is omitted.

$$[ Formula 3 ]$$

$${t}_{p} ( f ) = \frac{2 P ( f )}{{C}_{a}} + ( - \frac{{L}_{a}}{{C}_{a}} - \frac{{L}_{b}}{{C}_{b}} ) \qquad ( 4 )$$

In the mathematical formula (4), tp, Ca, Cb, La, and Lb are known as described above, so that the leakage position P can be calculated.

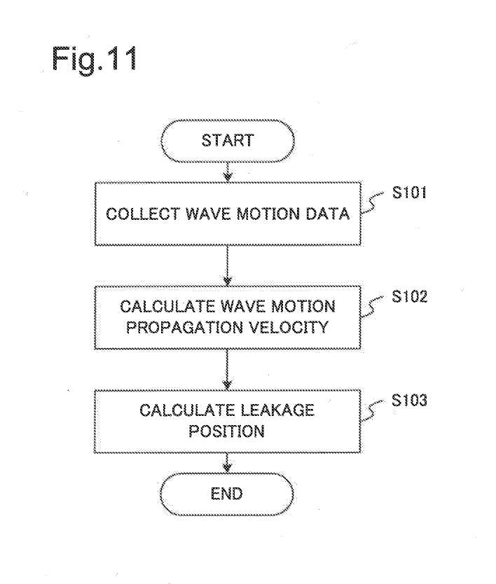

Processing for the leakage position analyzing method described above is also summarized as in the flowchart illustrated in FIG. 11.

First, the wave motion data about the wave motion that is applied by the wave motion applying device 102 and is detected by the first wave motion detector 101a and the second wave motion detector 101b is collected by the first wave motion data collector 103a and the second wave motion data collector 103b (step S101). The collected wave motion data is sent to the wave motion propagation velocity calculator 104.

Next, the wave motion propagation velocity calculator 104 or the leakage position calculator 105 calculates the wave motion propagation velocity by using the wave motion data about the wave motion detected in step S101 (step S102).

Next, the leakage position calculator 105 calculates the leakage position by using the wave motion propagation velocity calculated in step S102 (step S103).

Note that in the first example embodiment, the frequency dependence of the wave motion propagation velocity is approximated by the linear function related to the frequency. However, when the frequency range to be approximated is limited, the accuracy can be further enhanced.

### Second Example Embodiment

A leakage position analyzing system according to a second example embodiment is identical to the configuration of the leakage position analyzing system according to the first example embodiment. A leakage position analyzing method according to the second example embodiment is similar to the leakage position analyzing method according to the first example embodiment, except that the wave motion propagation velocity calculator 104 approximates, by a quadratic function, the wave motion propagation velocity of the first pipe 101a and the wave motion propagation velocity of the second pipe 101b at a plurality of frequencies. According to the second example embodiment, as illustrated in FIG. 3, in general, the graph illustrating the frequency dependence of the wave motion propagation velocity is a curve. Accordingly, the wave motion propagation velocity is approximated by the quadratic function, to thereby enhance the approximation is accuracy in a wide range, with the result that the accuracy for calculating the leakage position is enhanced. In the case of approximation by the quadratic function, mathematical formulas (5) and (6) are used.

[Formula 4]

Cₐ(f)=A₀+A₁f+A₂f (5)

C_{b}(f)=B₀+B₁f+B₂f (6)

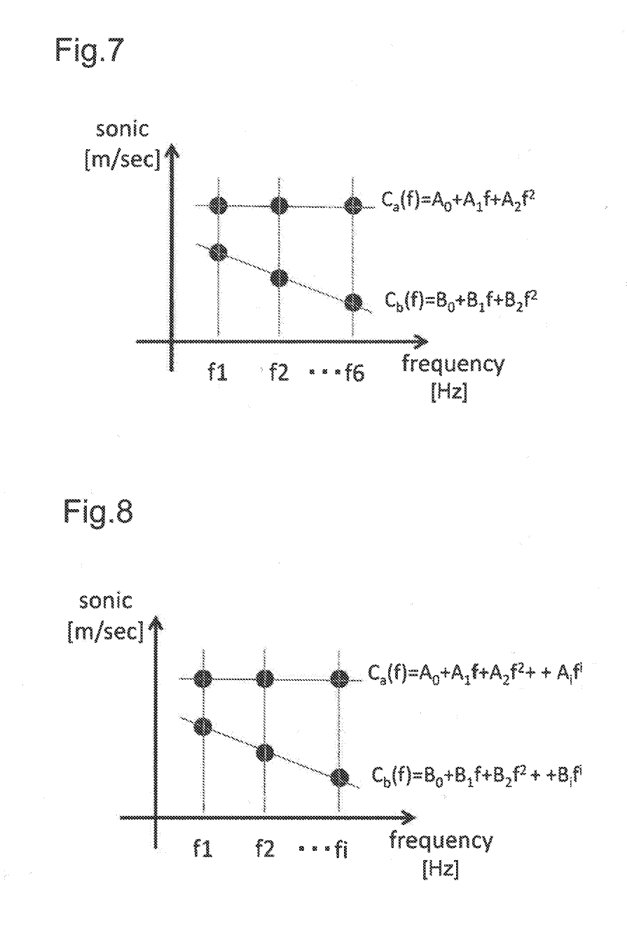

In the case of determining the unknown quantities according to the second example embodiment, as illustrated in FIG. 7, a plurality of (six in this example) frequency components tp are used. In addition, the unknown quantities can also be determined based on seven or more frequency components. In this case, the accuracy for estimating the unknown quantities is enhanced.

### Third Example Embodiment

A leakage position analyzing system according to a third example embodiment is identical to the configuration of the leakage position analyzing system according to the first example embodiment. A leakage position analyzing method according to the third example embodiment is similar to the leakage position analyzing method according to the first example embodiment, except that the wave motion propagation velocity calculator 104 approximates, by a function different from the function in the first example embodiment, the wave motion propagation velocity of the first pipe 101a and the wave motion propagation velocity of the second pipe 101b at a plurality of frequencies.

In data processing by the wave motion propagation velocity calculator 104, cubic or higher order functions as illustrated in FIG. 8 may be used as an approximation function. Further, if the approximation function can determine the unknown quantities, for example, an exponential function, a logarithmic function, and the like can also be used as needed.

### Fourth Example Embodiment

A program according to a fourth example embodiment is a program that enables a computer to execute the leakage position calculation method described above. The program according to the present example embodiment may be driven and processed by, for example, a processor such as a Central Processing Unit (CPU), a Network Processor (NP), or a microprocessor, or a circuit such as a semiconductor integrated circuit (Large Scale Integration (LSI)), and the like.

The program according to the fourth example embodiment may be recorded on, for example, a recording medium. The recording medium is not particularly limited. Examples of the recording medium include a random access memory (RAM), a read only memory (ROM), a hard disk (HD), an optical disk, a floppy (registered mark) disk (FD), and the like.

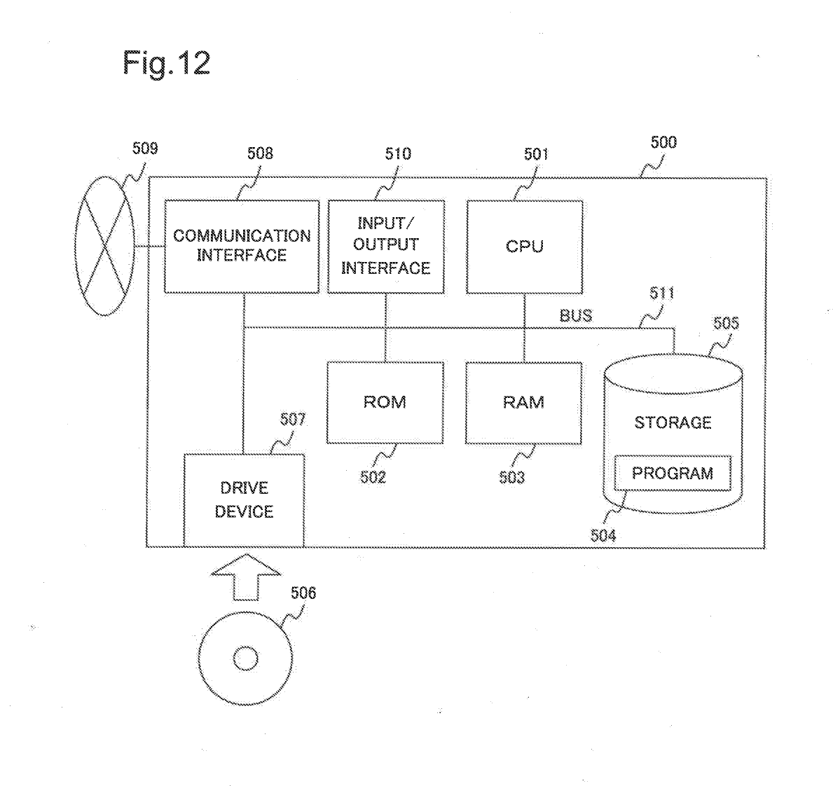

FIG. 12 illustrates an example of an information processing device that executes the program according to the fourth example embodiment. An information processing device 500 includes, for example, the following components.

A CPU 501

A ROM 502

A RAM 503

A program 504 loaded into the RAM 503

A storage 505 that stores the program 504

A drive device 507 that performs reading/writing the recording medium 506

A communication interface 508 to be connected to a communication network 509

An input/output interface 510 that performs data input/out

A bus 511 for connecting constituent elements to each other

Respective constituent elements of each device according to the example embodiments are implemented by causing the CPU 501 to acquire and execute the program 504 for implementing these functions. The program 504 for implementing the functions of the respective constituent elements of each device is stored in, for example, the storage 505 or the RAM 503 in advance and is read by the CPU 501 as needed. Note that the program 504 may be supplied to the CPU 501 via the communication network 509 and stored in the recording medium 506 in advance, and the drive device 507 may read the program and supply the read program to the CPU 501.

The method for implementing each device has various modifications. For example, each device may be implemented by any combination of an information processing device 500 and a program which are respectively different for each constituent element. Further, a plurality of constituent elements included in each device may be implemented by any combination of a single information processing device 500 and a program.

Some or all of the constituent elements of each device are implemented by general-purpose or dedicated circuitries including a processor and the like, or a combination thereof. These may be composed of a single chip, or may be composed of a plurality of chips connected through a bus. Some or all of the constituent elements of each device may also be implemented by the above-mentioned circuitries or the like and a program.

When some or all of the constituent elements of each device are implemented by a plurality of information processing devices, circuitries, or the like, the plurality of information processing devices, circuitries, or the like may be arranged in a centralized manner, or may be arranged in a distributed manner. For example, the information processing devices, circuitries, or the like may be implemented by a mode in which a client and server system, a cloud computing system, and the like are connected via a communication network.

### Fifth Example Embodiment

A schematic block diagram of FIG. 9 illustrates an example of a structure of a leakage position analyzing device according to a fifth example embodiment. As illustrated in the figure, a leakage position analyzing device 200 according to the fifth example embodiment includes the first wave motion detector 101a, the second wave motion detector 101b, and the leakage position calculator 105.

The first wave motion detector 101a and the second wave motion detector 101b may be any detector as long as it can detect a wave motion of a pipe. For example, the first wave motion detector 101a and the second wave motion detector 101b are a sensor for detecting a wave motion, a sensor for detecting a pressure fluctuation, or the like.

The first wave motion detector 101a is installed in a first pipe. The first wave motion detector 101a may be directly installed in the first pipe, or may be installed in the first pipe through a valve plug member. Examples of the valve plug member include a fire hydrant, a water shut-off valve, an air valve, and the like to be connected to the first pipe.

The second wave motion detector 101b is installed in a second pipe connected to the first pipe. The second wave motion detector 101b may be directly installed in the second pipe, or may be installed in the second pipe through the valve plug member. Examples of the valve plug member include a fire hydrant, a water shut-off valve, an air valve, and the like connected to the second pipe.

The leakage position calculator 105 calculates the fluid leakage position based on the difference between the time when the wave motion reaches the first wave motion detector 101a and the time when the wave motion reaches the first wave motion detector 101b, the length from the location where the first wave motion detector 101a is installed to the location of the connection with the second pipe, and the length from the location where the second pipe detector 101b is installed to the location of the connection with the first pipe.

### Sixth Example Embodiment

A schematic block diagram of FIG. 10 illustrates an example of a structure of a leakage position analyzing device according to a sixth example embodiment. As illustrated in the figure, a leakage position analyzing device 200 according to the sixth example embodiment is similar to the leakage position analyzing device according to the fifth example embodiment, except that the leakage position analyzing device 200 according to the sixth example embodiment further includes the wave motion propagation velocity calculator 104.

The wave motion propagation velocity calculator 104 calculates the wave motion propagation velocity of the first pipe and the wave motion propagation velocity of the second pipe at a plurality of frequencies based on the difference between the time when the wave motion reaches the first wave motion detector 101a and the time when the wave motion reaches the first wave motion detector 101b, the length from the location where the first wave motion detector 101a is installed to the location of the connection with the second pipe, and the length from the location where the second wave motion detector 101b is installed to the location of the connection with the first pipe.

Further, in the leakage position analyzing device 200 according to the sixth example embodiment, the leakage position calculator 105 calculates the fluid leakage position by using the wave motion propagation velocity of the first pipe and the wave motion propagation velocity of the second pipe at the plurality of frequencies.

While the present invention has been described above with reference to example embodiments, the present invention is not limited to the example embodiments. The structure and details of the present invention can be modified in various ways that can be understood by those skilled in the art within the scope of the present invention.

This application is based upon and claims the benefit of priority from Japanese patent application No. 2016-91996, filed on Apr. 28, 2016, the disclosure of which is incorporated herein in its entirety by reference.

The whole or part of the example embodiments described above can be described as, but not limited to, the following supplementary notes.

### (Supplementary Note 1)

A leakage position analyzing system including:

a first wave motion detector;

a second wave motion detector;

a wave motion applying device; and

a leakage position calculator, wherein

the first wave motion detector is a detector installed in a first pipe,

the second wave motion detector is a detector installed in a second pipe connected to the first pipe,

the wave motion applying device is a device that applies wave motion to a side not connected to the second pipe in the first pipe, from a location where the first wave motion detector is installed, and

the leakage position calculator is a device that calculates a fluid leakage position using a difference between a time when the wave motion reaches the first wave motion detector and a time when the wave motion reaches the second wave motion detector, a length of a part of the first pipe from the location where the first wave motion detector is installed, to a location of a connection with the second pipe, and a length of a part of the second pipe from a location where the second wave motion detector is installed, to a location of a connection with the first pipe.

### (Supplementary Note 2)

The leakage position analyzing system according to Supplementary note 1, further including a wave motion propagation velocity calculator that calculating a wave motion propagation velocity of the first pipe and a wave motion propagation velocity of the second pipe at a plurality of frequencies, using the difference between the time when the wave motion reaches the first wave motion detector and the time when the wave motion reaches the second wave motion detector, the length of the part of the first pipe from the location where the first wave motion detector is installed, to the location of the connection with the second pipe, and the length of the part of the second pipe from the location where the second wave motion detector is installed, to the location of the connection with the first pipe, wherein

the leakage position calculator calculates the fluid leakage position by using the wave motion propagation velocity of the first pipe and the wave motion propagation velocity of the second pipe at the plurality of frequencies.

### (Supplementary Note 3)

The leakage position analyzing system according to Supplementary note 2, wherein the wave motion propagation velocity calculator approximates, by a linear function, the wave motion propagation velocity of the first pipe and the wave motion propagation velocity of the second pipe at the plurality of frequencies.

### (Supplementary Note 4)

The leakage position analyzing system according to Supplementary note 2, wherein the wave motion propagation velocity calculator approximates, by a quadratic function, the wave motion propagation velocity of the first pipe and the wave motion propagation velocity of the second pipe at the plurality of frequencies.

### (Supplementary Note 5)

The leakage position analyzing system according to any one of Supplementary notes 1 to 4, further including a wave motion data collector that collects wave motion data detected by the first wave motion detector and the second wave motion detector.

### (Supplementary Note 6)

The leakage position analyzing system according to any one of Supplementary notes 2 to 5, further including a pipe information input device that inputting, to the wave motion propagation velocity calculator, information about the length of the part of the first pipe from the location where the first wave motion detector is installed, to the location of the connection with the second pipe, and the length of the part of the second pipe from the location where the second wave motion detector is installed, to the location of the connection with the first pipe.

### (Supplementary Note 7)

The leakage position analyzing system according to Supplementary note 6, wherein the pipe information input device is capable of inputting, to the wave motion propagation velocity calculator, at least one piece of information selected from a group including materials, diameters, and laying position information of the first pipe and the second pipe.

### (Supplementary Note 8)

A leakage position analyzing method including:

applying a wave motion from a location of where a first wave motion detector is installed, to a side not connected to a second pipe in the first pipe, the second pipe being connected to the first pipe; and

calculating a fluid leakage position, using a difference between a time when the wave motion reaches the first wave motion detector and a time when the wave motion reaches a second wave motion detector installed in the second pipe, a length of a part of the first pipe from the location where the first wave motion detector is installed, to a location of a connection with the second pipe, and a length of a part of the second pipe from a location where the second wave motion detector is installed, to a location of a connection with the first pipe.

### (Supplementary Note 9)

The leakage position analyzing method according to Supplementary note 8, further including:

calculating a wave motion propagation velocity of the first pipe and a wave motion propagation velocity of the second pipe at a plurality of frequencies, using the difference between the time when the wave motion reaches the first wave motion detector and the time when the wave motion reaches the second wave motion detector, the length of the part of the first pipe from the location where the first wave motion detector is installed, to the location of the connection with the second pipe, and the length of the part of the second pipe from the location where the second wave motion detector is installed, to the location of the connection with the first pipe; and

calculating the fluid leakage position by using the wave motion propagation velocity of the first pipe and the wave motion propagation velocity of the second pipe at the plurality of frequencies.

### (Supplementary Note 10)

The leakage position analyzing method according to Supplementary note 9, further including

approximating the wave motion propagation velocity of the first pipe and the wave motion propagation velocity of the second pipe at the plurality of frequencies, respectively, by a linear function.

### (Supplementary Note 11)

The leakage position analyzing method according to Supplementary note 9, further including

approximating the wave motion propagation velocity of the first pipe and the wave motion propagation velocity of the second pipe at the plurality of frequencies, respectively, by a quadratic function.

### (Supplementary Note 12)

The leakage position analyzing method according to any one of Supplementary notes 9 to 11, further including

using at least one piece of information selected from a group including materials, diameters, and laying position information of the first pipe and the second pipe.

### (Supplementary Note 13)

A program causing a computer to execute a leakage position analyzing method including:

applying a wave motion from a location of where first wave motion detector is installed, to a side not connected to a second pipe in the first pipe, the second pipe being connected to the first pipe; and

calculating a fluid leakage position, using a difference between a time when the wave motion reaches the first wave motion detector and a time when the wave motion reaches a second wave motion detector installed in the second pipe, a length of a part of the first pipe from the location where the first wave motion detector is installed, to a location of a connection with the second pipe, and a length of a part of the second pipe from a location where the second wave motion detector is installed, to a location of a connection with the first pipe.

### (Supplementary Note 14)

A computer-readable recording medium recording a program causing a computer to execute a leakage position analyzing method including:

applying a wave motion from a location of where a first wave motion detector is installed, to a side not connected to a second pipe in the first pipe, the second pipe being connected to the first pipe; and

calculating a fluid leakage position, using a difference between a time when the wave motion reaches the first wave motion detector and a time when the wave motion reaches a second wave motion detector installed in the second pipe, a length of a part of the first pipe from the location where the first wave motion detector is installed, to a location of a connection with the second pipe, and a length of a part of the second pipe from a location where the second wave motion detector is installed, to a location of a connection with the first pipe.

### (Supplementary Note 15)

A leakage position analyzing device including:

first wave motion detector;

second wave motion detector; and

leakage position calculator, wherein

the first wave motion detector is a detector installed in a first pipe,

the second wave motion detector is a detector installed in a second pipe connected to the first pipe, and

the leakage position calculator is a calculator that calculates a fluid leakage position using a difference between a time when the wave motion reaches the first wave motion detector and a time when the wave motion reaches the second wave motion detector, a length of a part of the first pipe from the location where the first wave motion detector is installed, to a location of a connection with the second pipe, and a length of a part of the second pipe from a location where the second wave motion detector is installed, to a location of a connection with the first pipe.

### (Supplementary Note 16)

The leakage position analyzing device according to Supplementary note 15, further including wave motion propagation velocity calculator, wherein

the wave motion propagation velocity calculator is a calculator that calculates a wave motion propagation velocity of the first pipe and a wave motion propagation velocity of the second pipe at a plurality of frequencies, using the difference between the time when the wave motion reaches the first wave motion detector and the time when the wave motion reaches the second wave motion detector, the length of the part of the first pipe from the location where the first wave motion detector is installed, to the location of the connection with the second pipe, and the length of the part of the second pipe from the location where the second wave motion detector is installed, to the location of the connection with the first pipe, and

the leakage position calculator calculates the fluid leakage position by using the wave motion propagation velocity of the first pipe and the wave motion propagation velocity of the second pipe at the plurality of frequencies.

### INDUSTRIAL APPLICABILITY

According to the present invention, it is possible to provide a leakage position analyzing system, a leakage position analyzing method, and a leakage position analyzing device which are capable of accurately analyzing a fluid leakage position even when a plurality of types of pipes coexist and materials or diameters of the pipes are different. The leakage position analyzing system, the leakage position analyzing method, and the leakage position analyzing device according to the present invention can be widely used for analyzing a leakage position of various types of pipes including pipes constituting a pipe network for transferring water, petroleum, gas, and the like.

### REFERENCE SIGNS LIST

100 Leakage position analyzing system
101a First wave motion detector
101b Second wave motion detector
102 Wave motion applying device
103a First wave motion data collector
103b Second wave motion data collector
104 Wave motion propagation velocity calculator
105 Leakage position calculator
107 Pipe information input device
120a First pipe
120b Second pipe
123a, 123b Valve plug member
200 Leakage position analyzing device

What is claimed is:

1. A leakage position analyzing system comprising:
a first wave motion detector that is installed in a first pipe;
a second wave motion detector that is installed in a second pipe connected to the first pipe;
a wave motion applying device that applies wave motion to a side not connected to the second pipe in the first pipe, from a location where the first wave motion detector is installed;
a leakage position calculator that calculates a fluid leakage position, using a difference between a time when the wave motion reaches the first wave motion detector and a time when the wave motion reaches the second wave motion detector, a length of a part of the first pipe from the location where the first wave motion detector is installed, to a location of a connection with the second pipe, and a length of a part of the second pipe from a location where the second wave motion detector is installed, to a location of a connection with the first pipe; and
a wave motion propagation velocity calculator that calculates a wave motion propagation velocity of the first pipe and a wave motion propagation velocity of the second pipe at a plurality of frequencies, using the difference between the time when the wave motion reaches the first wave motion detector and the time when the wave motion reaches the second wave motion detector, the length of the part of the first pipe from the location where the first wave motion detector is installed, to the location of the connection with the second pipe, and the length of the part of the second pipe from the location where the second wave motion detector is installed, to the location of the connection with the first pipe,
wherein the leakage position calculator calculates the fluid leakage position by using the wave motion propagation velocity of the first pipe and the wave motion propagation velocity of the second pipe at the plurality of frequencies, and
the wave motion propagation velocity calculator approximates, by a linear function or a quadratic function, the wave motion propagation velocity of the first pipe and the wave motion propagation velocity of the second pipe at the plurality of frequencies.

2. (canceled)

3. (canceled)

4. (canceled)

5. The leakage position analyzing system according to claim 1, further comprising a wave motion data collector that collects wave motion data detected by the first wave motion detector and the second wave motion detector.

6. The leakage position analyzing system according to claim 1, further comprising a pipe information input device that inputs, to the wave motion propagation velocity calculator, information about the length of the part of the first pipe from the location where the first wave motion detector is installed, to the location of the connection with the second pipe, and the length of the part of the second pipe from the location where the second wave motion detector is installed, to the location of the connection with the first pipe.

7. The leakage position analyzing system according to claim 6, wherein the pipe information input device is capable of inputting, to the wave motion propagation velocity calculator, at least one piece of information selected from a group including materials, diameters, and laying position information of the first pipe and the second pipe.

8. A leakage position analyzing method comprising:
applying a wave motion from a location of where a first wave motion detector is installed, to a side not connected to a second pipe in the first pipe, the second pipe being connected to the first pipe; and
calculating a fluid leakage position, using a difference between a time when the wave motion reaches the first wave motion detector and a time when the wave motion reaches a second wave motion detector installed in the second pipe, a length of a part of the first pipe from the location where the first wave motion detector is installed, to a location of a connection with the second pipe, and a length of a part of the second pipe from a location where the second wave motion detector is installed, to a location of a connection with the first pipe.

9. The leakage position analyzing method according to claim 8, further comprising:
calculating a wave motion propagation velocity of the first pipe and a wave motion propagation velocity of the second pipe at a plurality of frequencies, using the difference between the time when the wave motion reaches the first wave motion detector and the time when the wave motion reaches the second wave motion detector, the length of the part of the first pipe from the location where the first wave motion detector is installed, to the location of the connection with the second pipe, and the length of the part of the second pipe from the location where the second wave motion detector is installed, to the location of the connection with the first pipe; and
calculating the fluid leakage position by using the wave motion propagation velocity of the first pipe and the wave motion propagation velocity of the second pipe at the plurality of frequencies.

10. The leakage position analyzing method according to claim 9, further comprising
approximating the wave motion propagation velocity of the first pipe and the wave motion propagation velocity of the second pipe at the plurality of frequencies, respectively, by a linear function.

11. The leakage position analyzing method according to claim 9, further comprising
approximating the wave motion propagation velocity of the first pipe and the wave motion propagation velocity of the second pipe at the plurality of frequencies, respectively, by a quadratic function.

12. The leakage position analyzing method according to claim 9, further comprising
using at least one piece of information selected from a group including materials, diameters, and laying position information of the first pipe and the second pipe.

13. (canceled)

14. A leakage position analyzing device comprising:
a first wave motion detector that is installed in a first pipe;
a second wave motion detector that is installed in a second pipe connected to the first pipe; and
a leakage position calculator that calculates a fluid leakage position, using a difference between a time when the wave motion reaches the first wave motion detector and a time when the wave motion reaches the second wave motion detector, a length of a part of the first pipe from the location where the first wave motion detector is installed, to a location of a connection with the second pipe, and a length of a part of the second pipe from a location where the second wave motion detector is installed, to a location of a connection with the first pipe.

15. The leakage position analyzing device according to claim 14, further comprising:
wave motion propagation velocity calculator that calculates a wave motion propagation velocity of the first pipe and a wave motion propagation velocity of the second pipe at a plurality of frequencies, using the difference between the time when the wave motion reaches the first wave motion detector and the time when the wave motion reaches the second wave motion detector, the length of the part of the first pipe from the location where the first wave motion detector is installed, to the location of the connection with the second pipe, and the length of the part of the second pipe from the location where the second wave motion detector is installed, to the location of the connection with the first pipe, wherein
the leakage position calculator calculates the fluid leakage position by using the wave motion propagation velocity of the first pipe and the wave motion propagation velocity of the second pipe at the plurality of frequencies.
